(19) United States
(12) Patent Application Publication
(10) Pub. No.: US 2010/0123628 A1
(43) Pub. Date: May 20, 2010

(54) Multi-Band Antenna

(75) Inventors: Jia-Hung Su, Taipei Hsien (TW); Yung-Chih Tsai, Taipei Hsien (TW); Kai Shih, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/271,058

(22) Filed: Nov. 14, 2008

(51) Int. Cl. H01Q 1/38

(52) U.S. Cl. 343/700 MS

(57) ABSTRACT

A multi-band antenna has a base plate which defines a slot longitudinally extending and penetrating through one edge of the base plate to divide the base plate into a feeding portion and a grounding portion. A first radiating portion extends substantially perpendicularly from the feeding portion. A second radiating portion includes a connecting section substantially perpendicularly extending from the first radiating portion and substantially parallel and adjacent to the base plate and a radiating part connected with the connecting section and opposite to the base plate. The radiating part has a first radiating strip, a second radiating strip, a third radiating strip and an extended radiating strip, all of which shows a substantial stair-shape in combination.

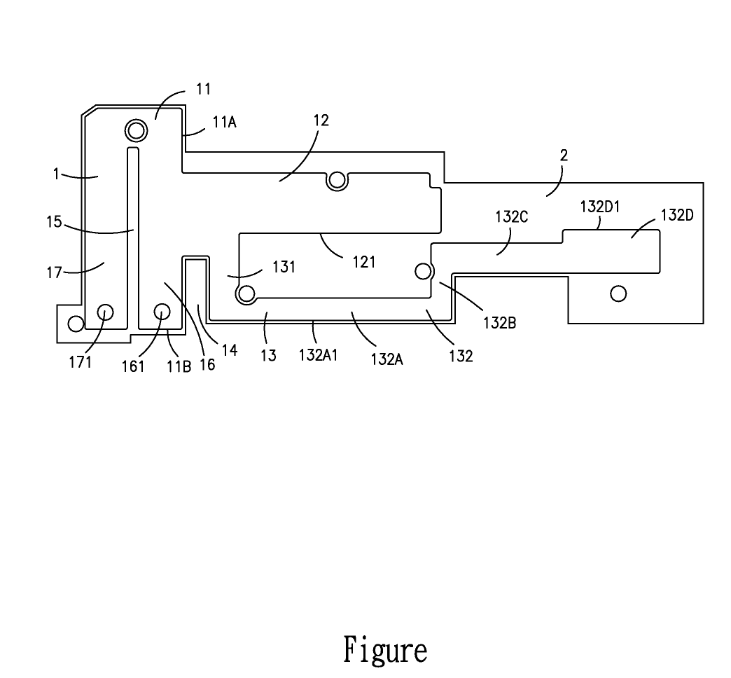

### BACKGROUND OF THE INVENTION

1. Field of the Invention

The present invention relates to an antenna, and more particularly to a multi-band antenna.

2. The Related Art

In recent years, portable wireless communication devices are becoming progressively popular. In order to communicate with other communication devices, various antennas are assembled in these devices for transmitting and receiving electromagnetic waves. Considering the miniaturization trend of the portable wireless communication device, the size of the antenna should be correspondingly reduced in order to be assembled in the limited space of the portable wireless communication device.

Among present wireless technologies, wireless communication bands include global system for mobile communications (GSM) band about 850 MHz, extended global system for mobile communications (EGSM) band about 900 MHz, digital cellular system (DCS) band about 1800 MHz, personal conferencing specification (PCS) band about 1900 MHz and wideband code division multiple access (WCDMA) band about 2000 MHz.

Many different types of antennas for the portable wireless communication devices are used, including planar inverted-F antennas, monopole antennas, loop antennas and the like. However, all of these antennas could not meet the demand of operating at multiple frequencies while the sizes thereof are reduced. Therefore, a disadvantage is exposed that covering multiple frequencies and occupying smaller space could not concurrent.

### SUMMARY OF THE INVENTION

It is an object of the present invention to provide a multi-band antenna covering multiple bands and having reduced size. The multi-band antenna includes a base plate, a first radiating portion and a second radiating portion. The base plate has a first edge and a second edge perpendicularly connected with the first edge. A slot is defined substantially at a middle portion of the base plate and parallel to the first edge and penetrating through the second edge to divide the base plate into a grounding portion and a feeding portion which defines the first edge as a long edge thereof. The first radiating portion extends substantially perpendicularly from the first edge of the base plate and has a transverse edge facing and substantially parallel to the second edge of the base plate. The second radiating portion has a connecting section extending substantially perpendicularly from the transverse edge of the first radiating portion and a radiating part which shows a substantial stair-shape connected with the connecting section. The radiating part has a first radiating strip extending substantially perpendicularly and in opposition to the first edge of the base plate from a free end of the connecting section, a second radiating strip extending substantially perpendicularly and towards the first radiating portion from a free end of the first radiating strip, a third radiating strip extending substantially perpendicularly and in opposition to the first radiating strip from a free end of the second radiating strip, and an extended radiating strip extending continuously from a free end of the third radiating strip and then expanding in opposition to the second radiating strip to be wider than the third radiating strip.

As described above, the arrangement of the first radiating portion and the second radiating portion makes the multi-band antenna transmit and receive multiple bands. The feeding portion and the grounding portion are separated by the slot, the radiating part of the second radiating portion is designed as a substantial stair-shape structure, which reduces the size of the multi-band antenna and makes the multi-band antenna take up smaller space when assembled in a portable wireless communication device.

### BRIEF DESCRIPTION OF THE DRAWINGS

The present invention will be apparent to those skilled in the art by reading the following description of an embodiment thereof, with reference to the attached drawings, in which:

FIGURE is a plan view of a multi-band antenna in accordance with the present invention;

### DETAILED DESCRIPTION OF THE PREFERRED EMBODIMENT

With reference to FIGURE, a multi-band antenna 1 according to the invention is etched by a flexible printed circuit board 2. The multi-band antenna 1 includes a substantially rectangular base plate 11 which defines a first edge 11A and a second edge 11B perpendicularly connected with the first edge 11A.

The base plate 11 has an elongated slot 15 longitudinally extending at a middle portion thereof and substantially parallel to the first edge 11A. The slot 15 penetrates through the second edge 11B to divide the base plate 11 into a grounding portion 17 and a feeding portion 16 which defines the first edge 11A as a long edge thereof. The feeding portion 16 defines a feeding point 161 adjacent to the second edge 11B, the grounding portion 17 defines a grounding point 171 adjacent to the second edge 11B too. The feeding portion 16 and the grounding portion 17 form a simulation inductance therebetween for tuning bandwidth and input impedance of the multi-band antenna 1 to realize impedance matching between the multi-band antenna 1 and a feeding cable (not shown).

A substantially rectangular first radiating portion 12 extends substantially perpendicularly from a middle portion of the first edge 11A. The first radiating portion 12 has a transverse edge 121 facing and substantially parallel to the second edge 11B of the base plate 11. A second radiating portion 13 extends from the transverse edge 121 and the width thereof is smaller than the width of the first radiating portion 12. The second radiating portion 13 includes a connecting section 131 extending substantially perpendicularly from the transverse edge 121 and a radiating part 132 which shows a substantial stair-shape connected with the connecting section 131. The connecting section 131 is arranged adjacent to the first edge 11A of the base plate 11 and an opening 14 is formed between the base plate 11 and the connecting section 131.

The radiating part 132 has a first radiating strip 132A extending substantially perpendicularly and in opposition to the first edge 11A of the base plate 11 from a free end of the connecting section 131 to be parallel to the first radiating portion 12. The first radiating strip 132A defines an outer edge 132A1 substantially at the same level with the second edge 11B of the base plate 11. A free end of the first radiating strip 132A extends substantially perpendicularly and towards the first radiating portion 12 to form a second radiating strip 132B adjacent to a free end of the first radiating portion 12. A third radiating strip 132C extends substantially perpendicularly and in opposition to the first radiating strip 132A from a free end of the second radiating strip 132B. An extended radiating strip 132D extends continuously from a free end of the third radiating strip 132C and then expands in opposition to the second radiating strip 132B to be wider than the third radiating strip 132C. The extended radiating strip 132D has a top edge 132D1 substantially in alignment with the transverse edge 121 of the first radiating portion 12.

When the multi-band antenna 1 is used in wireless communication, an electric current is fed into the multi-band antenna 1 by means of the feeding point 161. The first radiating portion 12 resonates at a higher frequency range covering from 1800 MHz to 2000 MHz; the second radiating portion 13 operates at a lower frequency range covering from 850 MHz to 900 MHz. Therefore, the multi-band antenna 1 obtains frequency range covering 850 MHz, 900 MHz, 1800 MHz, 1900 MHz and 2000 MHz corresponding to GSM band, EGMS band, DCS band, PCS band and WCDMA band in wireless communication.

As described above, the arrangement of the first radiating portion 12 and the second radiating portion 13 makes the multi-band antenna 1 transmit and receive multiple bands covering 850 MHz, 900 MHz, 1800 MHz, 1900 MHz and 2000 MHz. The feeding portion 16 and the grounding portion 17 are separated by the slot 15, the radiating part 132 of the second radiating portion 13 is designed as a substantial stair-shape structure, which reduces the size of the multi-band antenna 1 and makes the multi-band antenna 1 take up smaller space when assembled in a portable wireless communication device.

Moreover, the multi-band antenna 1 can be duly bent according to the internal structure of the portable wireless communication device for conveniently being assembled in the portable wireless communication device. The multi-band antenna 1 even can be fixed to a specific antenna holder and then assembled in the portable wireless communication device to further reduce the occupancy space. Therefore, the multi-band antenna 1 not only can transmit and receive multiple bands covering from 850 MHz to 2000 MHz, but also occupies smaller space in the portable wireless communication device.

What is claimed is:

1. A multi-band antenna, comprising:
a base plate having a first edge and a second edge perpendicularly connected with the first edge, a slot being defined substantially at a middle portion of the base plate and parallel to the first edge and penetrating through the second edge to divide the base plate into a grounding portion and a feeding portion defining the first edge as a long edge thereof;
a first radiating portion extending substantially perpendicularly from the first edge of the base plate, the first radiating portion having a transverse edge facing and substantially parallel to the second edge of the base plate; and
a second radiating portion having a connecting section extending substantially perpendicularly from the transverse edge of the first radiating portion and a radiating part which shows a substantial stair-shape connected with the connecting section, the radiating part having a first radiating strip extending substantially perpendicularly and in opposition to the first edge of the base plate from a free end of the connecting section, a second radiating strip extending substantially perpendicularly and towards the first radiating portion from a free end of the first radiating strip, a third radiating strip extending substantially perpendicularly and in opposition to the first radiating strip from a free end of the second radiating strip and an extended radiating strip extending continuously from a free end of the third radiating strip and then expanding in opposition to the second radiating strip to be wider than the third radiating strip.

2. The multi-band antenna as claimed in claim 1, wherein the connecting section of the second radiating portion is substantially parallel and adjacent to first edge of the base plate, and an opening is formed between the connecting section and base plate.

3. The multi-band antenna as claimed in claim 1, wherein the first radiating strip has an outer edge substantially at the same level as the second edge of the base plate, the extended radiating strip has a top edge substantially in alignment with the transverse edge of the first radiating portion.

4. The multi-band antenna as claimed in claim 1, wherein the feeding portion defines a feeding point thereon, the grounding portion defines a grounding thereon, both of the feeding point and the ground point are adjacent to the second edge of the base plate.
